(19) United States
(12) Patent Application Publication
(10) Pub. No.: US 2026/0208998 A1
(43) Pub. Date: Jul. 23, 2026

(54) INDIUM FOIL PROCESSING METHOD AND INDIUM FOIL PROCESSING MACHINE

(71) Applicant: HORNG TERNG AUTOMATION CO., LTD., Kaohsiung City (TW)

(72) Inventors: Yu-Hsien WANG, Kaohsiung City (TW); Jian-Hua CHEN, Kaohsiung City (TW)

(21) Appl. No.: 19/332,078

(22) Filed: Sep. 18, 2025

(30) Foreign Application Priority Data
Jan. 23, 2025 (TW) 114103073

(51) Int. Cl. B65H 43/00; B65H 29/24; G01B 11/02

(52) U.S. Cl. CPC B65H 43/00; B65H 29/241; G01B 11/026; B65H 2553/40; B65H 2701/173

(57) ABSTRACT

An indium foil processing method is disclosed. In this method, a placement head without carrying any indium foils is moved to a top of a laser distance sensor to use the laser distance sensor to perform a first measuring operation to obtain a reference height of the placement head without carrying any indium foils. The placement head is used to perform an indium foil suction operation. After the indium foil suction operation is completed, the placement head is moved to the top of the laser distance sensor and the laser distance sensor is used to perform a second measuring operation to obtain a detecting height of the placement head. A controller is used to determine whether an indium foil number sucked by the placement head during the indium foil suction operation is abnormal based on a difference between the reference height and the detecting height.

### CROSS - REFERENCE TO RELATED APPLICATION

This application claims priority to Taiwan Application Serial Number 114103073, filed January 23, 2025, which is herein incorporated by reference in its entirety.

### BACKGROUND

### FIELD OF INVENTION

The present disclosure relates to a processing method and a processing machine, and more particularly, to an indium foil processing method and an indium foil processing machine.

### DESCRIPTION OF RELATED ART

In an indium foil attaching process, a placement head normally sucks an indium foil and moves the indium foil to a working area to attach the indium foil every time. However, the placement head may suck overlapping indium foils during an actual operation of the machine. The prior art lacks height or thickness detective mechanisms of indium foils, such that the placement head will perform the subsequent attaching process regardless of whether the placement head sucks a single indium foil normally or two or more overlapping indium foils. If a product is processed with plural overlapping indium foils, a processing height of the processed product will be higher than an original design and may not meet an original design specification, resulting in a situation that the product has to be scrapped.

In the past, the detection of heat sink overlapping was usually performed by using an optical sensor to recorded a raising height of a Z-axis motor in a processing machine and conform that the Z-axis motor has risen to the height at which light can pass through, so as to determine whether the heat sinks overlap. When the raising height is higher than an expected height, it means that the heat sinks are overlapping. However, an indium foil is a new type of heat dissipation material, and the thickness of the indium foil is extremely thin and only 0.3 mm to 0.5 mm. Using the optical sensor to record the raising height of the Z-axis motor to detect the thickness of the indium foil has low distinguishability, and cannot accurately determine whether the indium foils overlap.

### SUMMARY

Therefore, one objective of the present disclosure is to provide an indium foil processing method and an indium foil processing machine which have high detection accuracy and can detect a new heat dissipation indium foil with an extremely thin thickness. Accordingly, using the processing method and the processing machine of the present disclosure can accurately determine whether there is a situation of overlapping indium foils, and remove the abnormal overlapping indium foils to prevent using the overlapping indium foils to process products, which causes that the products cannot be finished base on the original design and must be scrapped.

According to the objective of the present disclosure, an indium foil processing method is provided. In the method, a placement head without carrying any indium foils is moved to a top of a laser distance sensor to use the laser distance sensor to perform a first measuring operation to obtain a reference height of the placement head without carrying any indium foils. The placement head is used to perform an indium foil suction operation. After the indium foil suction operation is completed, the placement head is moved to the top of the laser distance sensor and the laser distance sensor is used to perform a second measuring operation to obtain a detecting height of the placement head. A controller is used to determine whether an indium foil number sucked by the placement head during the indium foil suction operation is abnormal based on a difference between the reference height and the detecting height.

According to an example of the present disclosure, determining whether the indium foil number sucked by the placement head during the indium foil suction operation is abnormal includes determining that the indium foil number sucked by the placement head during the indium foil suction operation is normal when the difference between the reference height and the detecting height is smaller than 1.2 times a thickness of an indium foil and larger than 0.8 times the thickness of the indium foil.

According to an example of the present disclosure, determining whether the indium foil number sucked by the placement head during the indium foil suction operation is abnormal includes determining that the indium foil number sucked by the placement head during the indium foil suction operation is abnormal when the difference between the reference height and the detecting height is larger than 1.5 times the thickness of the indium foil.

According to an example of the present disclosure, the reference height is a first distance between the placement head without carrying any indium foil and the laser distance sensor, and the detecting height is a second distance between the placement head after the indium foil suction operation and the laser distance sensor.

According to an example of the present disclosure, in the first measuring operation, the laser distance sensor is used to obtain a first height of a bottom of the placement head relative to the laser distance sensor. The laser distance sensor is used to obtain a second height of an imagine plane of the placement head relative to the laser distance sensor, in which the imagine plane is not located on the bottom of the placement head. A first difference between the second height and the first height is used as the reference height. In the second measuring operation, the laser distance sensor is used to obtain a third height of the bottom of the placement head relative to the laser distance sensor. The laser distance sensor is used to obtain a fourth height of the imagine plane of the placement head relative to the laser distance sensor. A second difference between the third height and the fourth height is used as the detecting height.

According to an example of the present disclosure, when the indium foil number sucked by the placement head during the indium foil suction operation is determined to be abnormal and the placement head sucks plural indium foils, the indium foil processing method further includes using the placement head to deliver the indium foils to a recycle area to recycle the indium foils.

According to an example of the present disclosure, before the placement head is used to perform the indium foil suction operation, the indium foil processing method further includes using an upper detecting device to detect a center position of a substrate in a working area. When it is determined that the indium foil number sucked by the placement head during the indium foil suction operation is normal and the placement head sucks a single indium foil, the indium foil processing method further includes using the placement head to deliver the indium foil to a top of a lower detecting device to use the lower detecting device to detect a center position of the indium foil, and using the controller to perform an alignment operation based on the center position of the substrate and the center position of the indium foil.

According to the objective of the present disclosure, an indium foil processing machine is further provided, which includes a platform, at least one feeding device, a delivery device, at least one placement head, at least one laser distance sensor, and a controller. The platform has at least one working area and at least one feeding area. The feeding device is disposed in the feeding area, and configured to supply plural indium foils. The delivery device is disposed in the working area, and configured to deliver the substrates along a direction. The placement head is disposed on the platform and movably along an X axis, a Y axis, and a Z axis on the platform, and is configured to suck and deliver the indium foils, and attach the indium foil on the substrates. The laser distance sensor is disposed on the platform, and configured to measure a reference height of the placement head without carrying any indium foils, and a detecting height of the placement head after the placement head performs an indium foil suction operation. The controller is signally connected to the laser distance sensor, and is configured to receive the reference height and the detecting height and determine whether an indium foil number sucked by the placement head during the indium foil suction operation is abnormal based on a difference between the reference height and the detecting height.

According to an example of the present disclosure, the platform further includes a recycle area. When it is determined that the indium foil number sucked by the placement head during the indium foil suction operation is abnormal and the indium foil number sucked by the placement head is plural, the placement head is further configured to deliver the indium foils to the recycle area to recycle the indium foils.

According to an example of the present disclosure, the recycle area is disposed at one side of the working area and at the same side as the feeding area.

According to an example of the present disclosure, a number of the feeding areas is the same as a number of the working areas.

According to an example of the present disclosure, each placement head corresponds to each working area and each feeding device.

According to an example of the present disclosure, the indium foil processing machine further includes at least one upper detecting device and at least one lower detecting device. The upper detecting device is movably disposed on the platform, and signally connected to the controller. The upper detecting device is configured to measure a center position of each of the substrates in the working area, and transmits the center positions to the controller. The lower detecting device is disposed on the platform, and signally connected to the controller. The lower device is configured to measure a center position of an indium foil sucked by the placement head, and transmit the center position of the indium foil to the controller to provide the controller for the controller to perform an alignment operation.

According to an example of the present disclosure, a number of the upper detecting devices corresponds to a number of the working areas.

According to an example of the present disclosure, a number of the lower detecting devices corresponds to a number of the working areas.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic diagram illustrating an indium foil processing machine according to an embodiment of the present disclosure.

FIG. 2 is a block diagram illustrating an indium foil processing machine according to an embodiment of the present disclosure.

FIG. 3 is a schematic flowchart illustrating an indium foil processing method according to a first embodiment of the present disclosure.

FIG. 4 to FIG. 6 are schematic diagrams of devices for performing various intermediate stages of an indium foil processing method of the first embodiment.

FIG. 7 is a schematic flowchart illustrating an indium foil processing method according to a second embodiment of the present disclosure.

FIG. 8 to FIG. 10 are schematic diagrams of devices for performing various intermediate stages of an indium foil processing method of the second embodiment.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms "first", "second", and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms "connected", "electrically connected", or the like between two components referred to in the present disclosure are not limited to the direct connection or electrical connection of the two components, and may also include indirect connection or electrical connection as required.

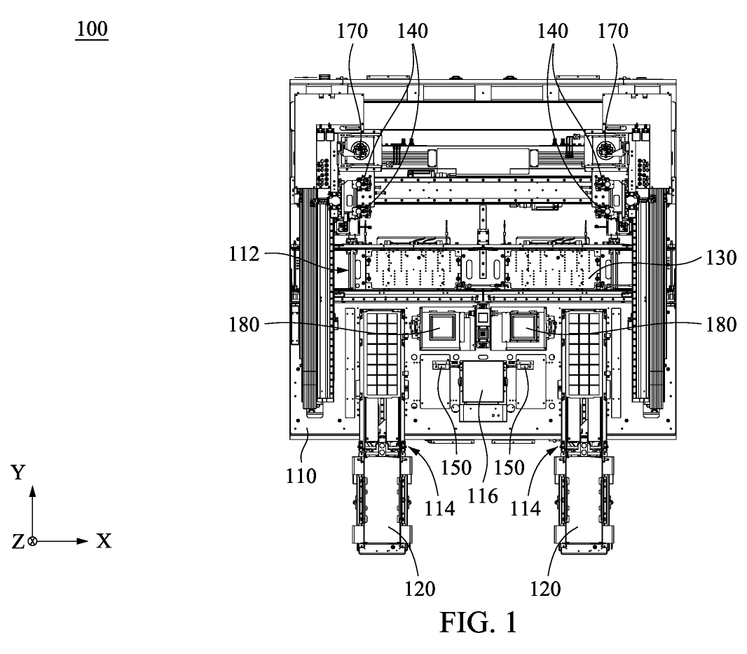

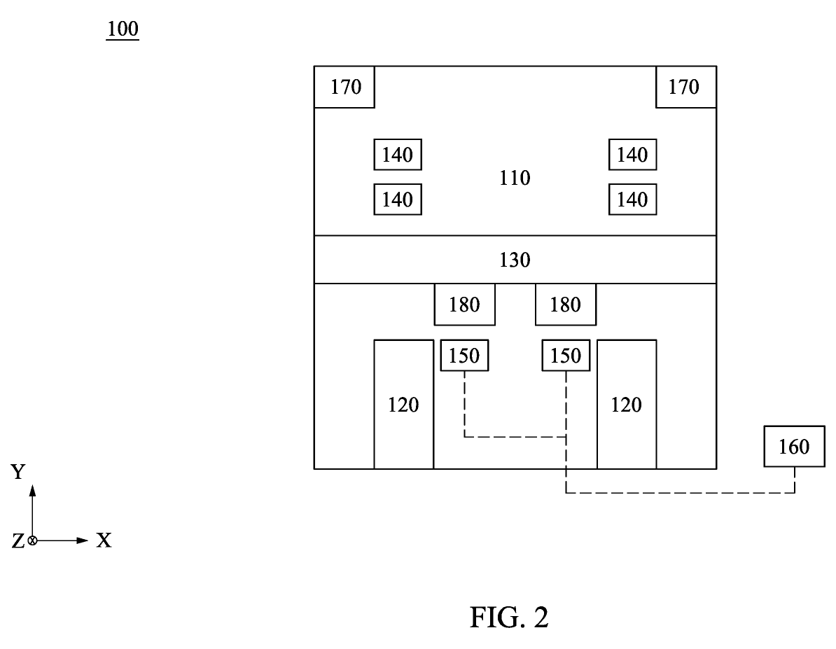

Refer to FIG. 1 and FIG. 2. FIG. 1 is a schematic diagram illustrating an indium foil processing machine 100 according to an embodiment of the present disclosure, and FIG. 2 is a block diagram illustrating an indium foil processing machine 100 according to an embodiment of the present disclosure. The indium foil processing machine 100 is applicable to perform an indium foil attaching operation during semiconductor process. The indium foil processing machine 100 may mainly include a platform 110, at least one feeding device 120, a delivery device 130, at least one placement head 140, at least one laser distance sensor 150, and a controller 160.

The platform 110 has at least one working area 112 and at least one feeding area 114. In some examples, as shown in FIG. 1, the working area 112 is long shaped, and may be adjacent to a center of the platform 110 and may be parallel to a direction X across the platform 110. The working area 112 can be disposed on the platform 110 in different orientations, and the present disclosure is not limited thereto. The working area 112 may provide a space for delivering substrates and processing operations. A number of the feeding areas 114 may be the same as a number of the working areas 112, and the feeding areas 114 correspond to the working areas 112 respectively. The feeding area 114 is disposed on the platform 110 and located at a side of the corresponding working area 112. The feeding device 120 is disposed correspondingly in the feeding area 114, and may supply the indium foils required by indium foil processing.

The delivery device 130 is disposed in the working area 112. In the example that the working area 112 is disposed in the platform 110 parallel to the direction X, the delivery device 130 can deliver the substrates along the direction X. The placement head 140 is disposed on the platform 110, and may move along the direction X, a direction Y, and a direction Z. The direction X, the direction Y, and the direction Z are perpendicular to each other. Each placement head 140 may correspond to one working area 112 and one feeding device 120. The placement head 140 may suck the indium foils supplied by the corresponding feeding device 120, deliver the sucked indium foils to the corresponding working area 112, and attach the sucked indium foils on the substrates delivered by the delivery device 130 in the working area 112.

The laser distance sensor 150 may correspond to the feeding area 114. The laser distance sensor 150 is disposed on the platform 110. In the example of FIG. 1, the laser distance sensor 150 is located at one side of the working area 112, and adjacent to the corresponding feeding area 114. The laser distance sensor 150 is configured to measure a reference height of the placement head 140 without carrying any indium foils, and a detecting height of the placement head 140 after the placement head 140 performs the indium foil suction operation from the corresponding feeding device 120.

Specifically, when the placement head 140 does not carry any indium foils, the laser distance sensor 150 may measure a distance of a bottom 142 of the placement head 140 moving to the top of the laser distance sensor 150 and a distance of an imaging plane 144 of the placement head 140 that is different from the bottom 142. The reference height can be obtained from the two distances. On the other hand, after the placement head 140 performs an indium foil suction operation, the laser distance sensor 150 may measure the distance of the bottom 142 of the placement head 140 moving to the top of the laser distance sensor 150 and the distance of the imaging plane 144 of the placement head 140 that is different from the bottom 142 again. The detecting height can be obtained from the two distances that are measured again.

Referring to FIG. 2, the controller 160 may be integrated in the indium foil processing machine 100, or disposed separately. For example, the controller 160 may be integrated into a computer used with the indium foil processing machine 100, such as an industrial computer, or may be directly implemented by a central processing unit of a computer used with the indium foil processing machine 100. Additionally, the controller 160 may also be separately disposed on the platform 110, but this is not limited thereto. The controller 160 may be signally connected to the laser distance sensor 150 via a wired means or a wireless means. Accordingly, the controller 160 may receive the distance information measured by the laser distance sensor 150. The controller 160 may use the distance information to obtain or calculate the reference height and the detecting height. The controller 160 may then calculate a difference between the reference height and the detecting height, and determine whether an indium foil number sucked by the placement head 140 during the indium foil suction operation is abnormal based on the difference between the reference height and the detecting height.

In the example of FIG. 1, the platform 110 further includes a recycle area 116. The recycle area 116 is disposed at one side of the working area 112, and at the same side as the feeding area 114. For example, when the platform 110 has two feeding areas 114, the indium foil processing machine 100 includes two laser distance sensors 150 disposed between the two feeding areas 114, and the recycle area 116 may be disposed between the two laser distance sensors 150. The recycle area 116 may be used to recycle abnormal indium foils. When the controller 160 determines that the indium foil number sucked by the placement head 140 during the indium foil suction operation is abnormal and the placement head 140 sucks two or more indium foils, the placement head 140 may deliver the indium foils to the recycle area 116 to recycle the indium foils to prevent processing products with an abnormal number of the indium foils.

In some examples, the indium foil processing machine 100 further includes at least one upper detecting device 170 and at least one lower detecting device 180. The number of the upper detecting device 170 and the number of the lower detecting device 180 both correspond to that of the working area 112. The upper detecting device 170 is movably disposed on the platform 110, and may be signally connected to the controller 160 via a wired means or a wireless means. The upper detecting device 170 may measure a center position of each substrate in the working area 112 and transmit the center position of each substrate to the controller 160. The lower detecting device 180 is disposed on the platform 110, and may be signally connected to the controller 160 via a wired means or a wireless means. After the placement head 140 sucks the indium foil, the placement head 140 moves to a top of the lower detecting device 180. The lower detecting device 180 may measure a center position of the indium foil sucked by the placement head 140, and transmit the center position of the indium foil to the controller 160. The controller 160 may utilize the information of the center position of the substrate and the center position of the indium foil to perform an alignment operation, such that the indium foil can be attached on the substrate accurately.

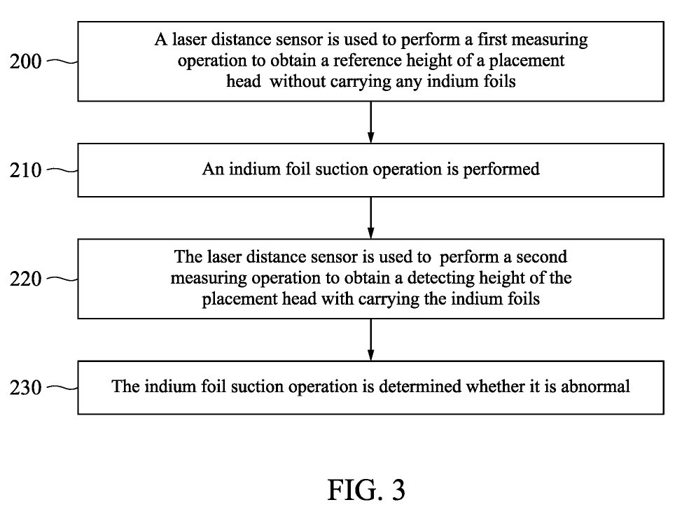

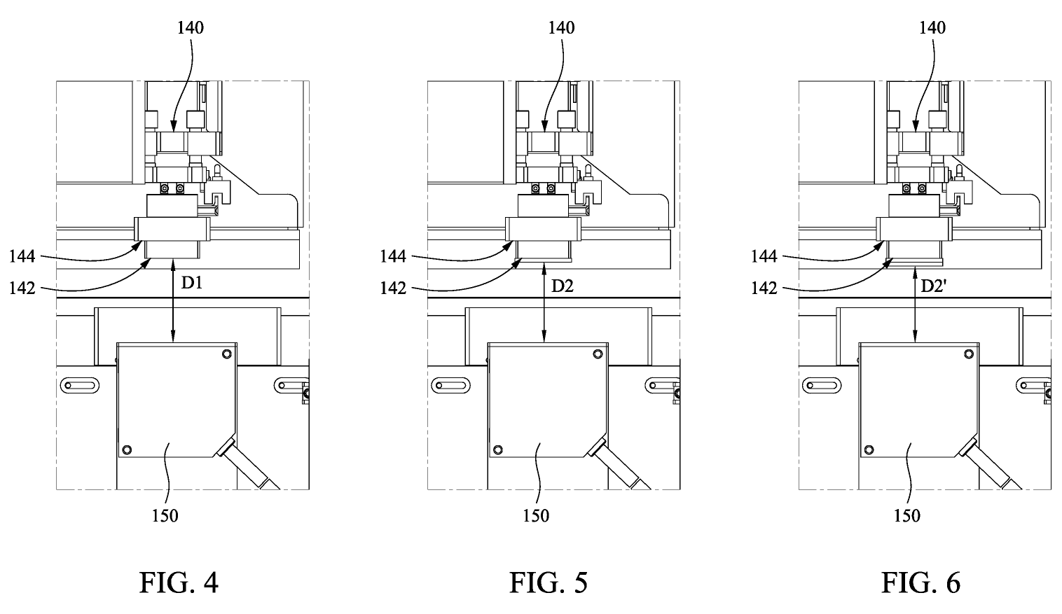

Referring FIG. 1 to FIG. 6 simultaneously, in which FIG. 3 is a schematic flowchart illustrating an indium foil processing method according to a first embodiment of the present disclosure, FIG. 4 to FIG. 6 are schematic diagrams of devices for performing various intermediate stages of the indium foil processing method of the first embodiment. When the indium foil processing method is performed, a step 200 may be first performed to move the placement head 140 without carrying any indium foils to the top of the corresponding laser distance sensor 150, and then utilize the laser distance sensor 150 to perform the first measuring operation, as shown in FIG. 4. In the first measuring operation, the laser distance sensor 150 is used to measure a first distance D1 between the bottom 142 of the placement head 140 without carrying any indium foils and the laser distance sensor 150. In this embodiment, the first distance D1 is used as a reference height of the placement head 140 without carrying any indium foils. The laser distance sensor 150 may transmit the information of the first distance D1 to the controller 160 via signal transmission.

After the reference height of the placement head 140 is obtained, a step 210 may be performed to move the placement head 140 to the top of the corresponding feeding area 114, and utilize the placement head 140 to perform the indium foil suction operation to suck the indium foil from the feeding device 120 in FIG. 1.

After the indium foil suction operation, a step 220 may be performed to move the placement head 140 to the top of the laser distance sensor 150, and then utilize the laser distance sensor 150 to perform a second measuring operation. In the second measuring operation, the laser distance sensor 150 is used to measure a second distance D2 between the bottom 142 of the placement head 140 after the indium foil suction operation and the laser distance sensor 150, as shown in FIG. 5. At this moment, the bottom 142 of the placement head 140 has sucked the indium foil, and the second distance D2 may be a distance between the indium foil and the laser distance sensor 150. In the present embodiment, the second distance D2 is used as a detecting height of the placement head 140 after the indium foil suction operation. The laser distance sensor 150 may transmit the information of the second distance D2 to the controller 160 via signal transmission.

In the example of FIG. 6, an overlapping situation of the indium foils occurs during the indium foil suction operation. Under such a situation, the laser distance sensor 150 measures a second distance D2’ between the bottom 142 of the placement head 140 after the indium foil suction operation and the laser distance sensor 150 in the second measuring operation. Under this situation, the second distance D2’ is the detecting height of the placement head 140 after indium foil suction operation. The laser distance sensor 150 may similarly transmit the information of the measured second distance D2’ to the controller 160 via signal transmission.

After the controller 160 obtains the reference height and the detecting height, the controller 160 may be used to perform a step 230. In the step 230, the controller 160 may first calculate a difference between the reference height and the detecting height, and then determine whether an indium foil number sucked by the placement head 140 during the indium foil suction operation is abnormal based on the difference between the reference height and the detecting height. In the situation of FIG. 5, the placement head 140 only sucks one indium foil, indicating that the indium foil number sucked by the placement head 140 during the indium foil suction operation is normal. In some examples, at this time, the second distance D2 is substantially equal to a value obtained by subtracting the thickness of the indium foil from the first distance D1. The thickness of the indium foil is the difference between the reference height and the detecting height.

The thicknesses of the indium foils may differ from each other due to manufacturing tolerances, or the laser distance sensor 150 may also have measurement errors. Therefore, in other examples, when the controller 160 calculates that the difference between the reference height and the detecting height which is smaller than 1.2 times the thickness of the indium foil and greater than 0.8 times the thickness of the indium foil, the controller 160 determines the indium foil number sucked by the placement head 140 during the indium foil suction operation is normal.

In the situation shown in FIG. 6, the placement head 140 sucks two indium foils that means the placement head 140 sucks overlapping indium foils, and the indium foil number sucked by the placement head 140 during the indium foil suction operation is abnormal. At this time, a difference between the second distance D2’ and the first distance D1 calculated by the controller 160, that is the difference between the reference height and the detecting height, is significantly greater than the thickness of one single indium foil, and the controller 160 determines that the indium foil suction operation of the placement head 140 is abnormal.

The manufacturing tolerances of the indium foils and the measurement errors of the laser distance sensor 150 are taken into consideration. In other examples, when the controller 160 calculates that the difference between the reference height and the detecting height is greater than 1.5 times the thickness of the indium foil, the controller 160 determines that the indium foil suction number sucked by the placement head 140 during the indium foil suction operation is abnormal.

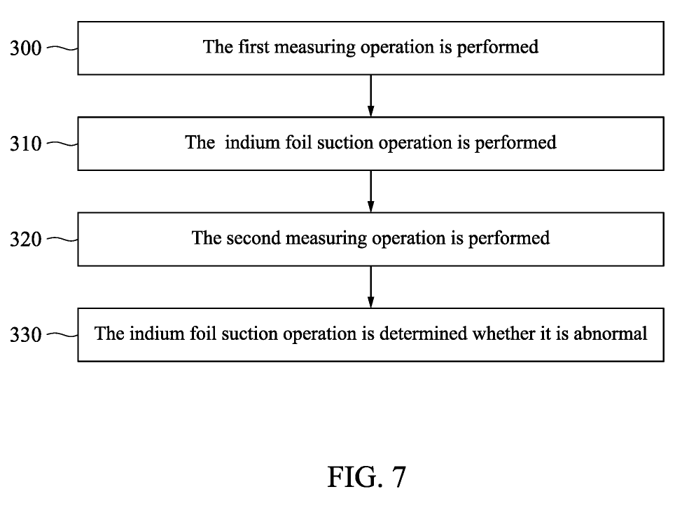

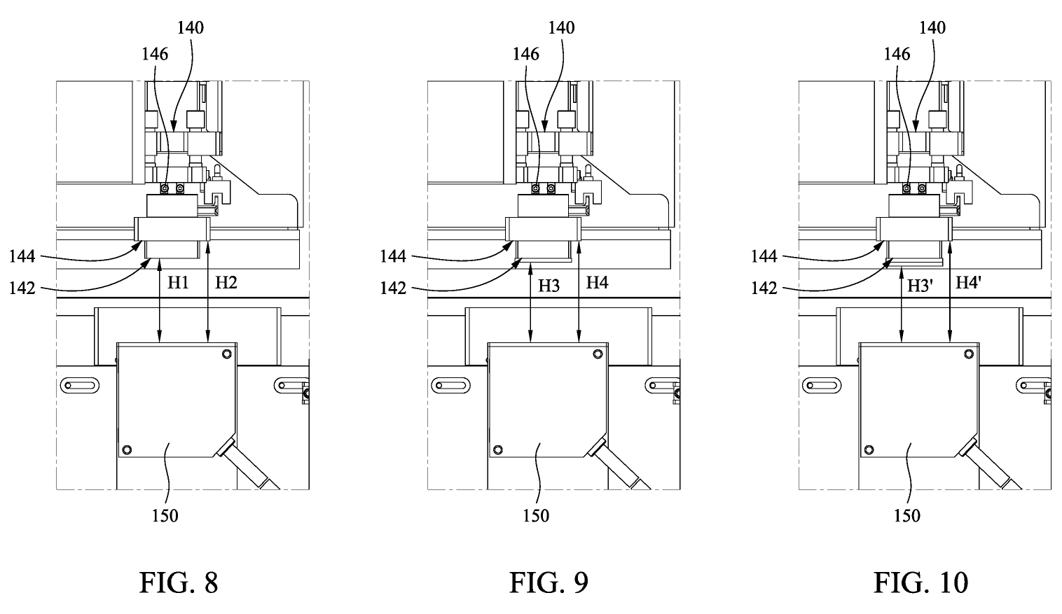

Referring to FIG.1, FIG. 2, and FIG. 7 to FIG. 10 simultaneously, in which FIG. 7 is a schematic flowchart illustrating an indium foil processing method according to a second embodiment of the present disclosure, and FIG. 8 to FIG. 10 are schematic diagrams of devices for performing various intermediate stages of the indium foil processing method of the second embodiment. In the performing of the indium foil processing operation of the second embodiment, a step 300 may be first performed to move the placement head 140 without carrying any indium foils to the top of the laser distance sensor 150, and then a first measuring operation is performed by using the laser distance sensor 150, as shown in FIG. 8. In the first measuring operation, the laser distance sensor 150 is used to measure a distance between the bottom 142 of the placement head 140 and the laser distance sensor 150 to obtain a first height H1. Simultaneously, the laser distance sensor 150 is also used to measure a distance between the imaging plane 144 of the placement head 140 and the laser distance sensor 150 to obtain a second height H2. In the present embodiment, a first difference between the first height H1 and the second height H2 is used as a reference height. The laser distance sensor 150 can transmit the information of the first height H1 and the second height H2 to the controller 160 via signal transmission.

In some examples, a step 310 may be performed after using the controller 160 to calculate the first difference between the first height H1 and the second height H2 to obtain the reference height. In the step 310, the placement head 140 is moved to the top of the feeding area 114 to perform the indium foil suction operation by using the placement head 140 to suck the indium foils from the feeding device 120.

After the indium foil suction operation, a step 320 may be performed to move the placement head 140 to the top of the laser distance sensor 150, and then use the laser distance sensor 150 to perform a second measuring operation. As shown in FIG. 9, in the second measuring operation, the laser distance sensor 150 is used to measure a distance between the bottom 142 of the placement head 140 after the indium foil suction operation and the laser distance sensor 150 to obtain a third height H3. The laser distance sensor 150 is used to measure a distance between the imaging plane 144 of the placement head 140 after the indium foil suction operation and the laser distance sensor 150 to obtain a fourth height H4. In the present embodiment, a second difference between the third height H3 and the fourth height H4 is used as a detecting height. The laser distance sensor 150 may transmit the information of the third height H3 and the fourth height H4 to the controller 160 via signal transmission.

In the example of FIG. 10, an overlapping situation of the indium foils occurs in the indium foil suction operation. Under such a situation, the laser distance sensor 150 is used to measure the distance between the bottom 142 of the placement head 140 after the indium foil suction operation and the laser distance sensor 150, and the distance between the imaging plane 144 of the placement head 140 after the indium foil suction operation and the laser distance sensor 150 to respectively obtain a third height H3’ and a fourth height H4’ during the second measuring operation. In the present embodiment, a second difference between the third height H3’ and the fourth height H4’ is used as a detecting height. The laser distance sensor 150 may transmit the information of the third height H3’ and the fourth height H4’ to the controller 160 via signal transmission.

In some examples, the controller 160 may be used to calculate the second difference between the third height H3 and the fourth height H4, or the second difference between the third height H3’ and the fourth height H4’ to obtain a corresponding detecting height. After the controller 160 calculates the reference height and the detecting height, a step 330 may be performed. In the step 330, the controller 160 may be first used to calculate a difference between the reference height and the detecting height, and then to determine whether the indium foil number sucked by the placement head 140 during the indium foil suction operation is abnormal based on the difference between the reference height and the detecting height. In the example shown in FIG. 9, the placement head 140 only sucks one single indium foil, indicating that the indium foil suction operation is normal. In some examples, the detecting height is substantially equal to the reference height added the thickness of the indium foil.

The thicknesses of the indium foils may differ from each other due to manufacturing tolerances, or the laser distance sensor 150 may also have measurement errors. In other examples, when the controller 160 calculates that the difference between the reference height and the detecting height is smaller than 1.2 times the thickness of the indium foil and greater than 0.8 times the thickness of the indium foil, the controller 160 determines the indium foil number sucked by the placement head 140 during the indium foil suction operation is normal.

In the situation shown in FIG. 10, the placement head 140 sucks two indium foils, indicating that the placement head 140 sucks overlapping indium foils, and the indium foil number sucked by the placement head 140 during the indium foil suction operation is abnormal. At this moment, the difference between the reference height and the detecting height calculated by the controller 160 is significantly greater than the thickness of one single indium foil, and the controller 160 determines that the indium foil suction operation performed by the placement head 140 is abnormal based on the difference.

In other examples, in consideration of the manufacturing tolerances and the measurement errors of the indium foils, when the controller 160 calculates that the difference between the reference height and the detecting height is greater than 1.5 times the thickness of the indium foil, the controller 160 determines the indium foil number sucked by the placement head 140 during the indium foil suction operation is abnormal.

In the second embodiment, in consideration of an elastic change caused by a spring 146 above the placement head 140, the placement head 140 may not return to an original height after performing the indium foil suction operation. However, a relative distance between the imaging plane 144 and the bottom 142 of the placement head 140 is fixed. Therefore, the difference between the detecting height and the reference height obtained by the second embodiment cannot be affected by the elastic change. Therefore, compared with the first embodiment, the second embodiment can more accurately determine whether the abnormal overlapping situation has occurred during the indium foil suction operation of the placement head 140.

In some examples, when the controller 160 calculates the difference between the reference height and the detecting height and then determines that the indium foil suction operation of the placement head 140 is abnormal, that is the placement head 140 may suck two or more indium foils, and the indium foil processing method further uses the placement head 140 to deliver the abnormal numbers of the indium foils to the recycle area 116 to recycle the indium foils. Therefore, it can prevent the abnormal numbers of the indium foils from being used in subsequent product processing, causing product abnormalities, or even scrapping of the products.

In some examples, before the placement head 140 performs the indium foil suction operation, the indium foil processing operation may use the upper detecting device 170 to first detect the center position of the substrate to be attached in the working area 112, and transmit the information of the center position of the substrate to the controller 160. In the indium foil processing method, after the placement head 140 performs the indium foil suction operation and when the controller 160 determines that the indium foil number sucked by the placement head 140 during the indium foil suction operation is normal, the placement head 140 is first used to deliver the indium foil to the top of the lower detecting device 180 to use the lower detecting device 180 to detect the center position of the indium foil. Then, the lower detecting device 180 is used to transmit the information of the center position of the indium foil to the controller 160. Subsequently, the controller 160 is used to perform an alignment operation based on the center position of the substrate and the center position of the indium foil to control the placement head 140 to change the orientation of the sucked indium foil to align the center position of the indium foil with the center position of the substrate. Therefore, the placement head 140 can accurately attach the sucked indium foil on the substrate in the working area 112.

According to the aforementioned embodiments, one advantage of the present disclosure is that the indium foil processing method can measure and determine whether the indium foil number after the indium foil suction operation is abnormal, and then perform different subsequent actions based on the suction situation. When it is determined that the indium foil suction operation is abnormal, the abnormal number of the indium foils are removed to prevent using the abnormal number of the indium foils to process products, which causes that the products cannot be finished base on the original design and must be scrapped.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An indium foil processing method, comprising:
moving a placement head without carrying any indium foils to a top of a laser distance sensor to use the laser distance sensor to perform a first measuring operation to obtain a reference height of the placement head without carrying any indium foils;
using the placement head to perform an indium foil suction operation;
moving the placement head to the top of the laser distance sensor and using the laser distance sensor to perform a second measuring operation to obtain a detecting height of the placement head after the indium foil suction operation is performed; and
using a controller to determine whether an indium foil number sucked by the placement head during the indium foil suction operation is abnormal based on a difference between the reference height and the detecting height.

2. The indium foil processing method of claim 1, wherein determining whether the indium foil number sucked by the placement head during the indium foil suction operation is abnormal comprises determining that the indium foil number sucked by the placement head during the indium foil suction operation is normal when the difference between the reference height and the detecting height is smaller than 1.2 times a thickness of an indium foil and greater than 0.8 times the thickness of the indium foil.

3. The indium foil processing method of claim 1, wherein determining whether the indium foil number sucked by the placement head during the indium foil suction operation is abnormal comprises determining that the indium foil number sucked by the placement head during the indium foil suction operation is abnormal when the difference between the reference height and the detecting height is greater than 1.5 times a thickness of an indium foil.

4. The indium foil processing method of claim 1, wherein the reference height is a first distance between the placement head without carrying any indium foils and the laser distance sensor, and the detecting height is a second distance between the placement head and the laser distance sensor after the indium foil suction operation.

5. The indium foil processing method of claim 1, wherein:
performing the first measuring operation comprises:
using the laser distance sensor to obtain a first height of a bottom of the placement head relative to the laser distance sensor;
using the laser distance sensor to obtain a second height of an imaging plane of the placement head relative to the laser distance sensor, wherein the imaging plane is not located on the bottom; and
using a first difference between the first height and the second height as the reference height; and
performing the second measuring operation comprises:
using the laser distance sensor to obtain a third height of the bottom of the placement head relative to the laser distance sensor;
using the laser distance sensor to obtain a fourth height of the imaging plane of the placement head relative to the laser distance sensor; and
using a second difference between the third height and the fourth height as the detecting height.

6. The indium foil processing method of claim 1, wherein when the indium foil number sucked by the placement head during the indium foil suction operation is abnormal and the placement head sucks a plurality of indium foils, the indium foil processing method comprises using the placement head to deliver the indium foils to a recycle area to recycle the indium foils.

7. The indium foil processing method of claim 1, wherein before using the placement head to perform the indium foil suction operation, the indium foil processing method further comprises:
using an upper detecting device to detect a center position of a substrate in a working area, and when it is determined that the indium foil number sucked by the placement head during the indium foil suction operation is normal and the placement head sucks a single indium foil, the indium foil processing method further comprises using the placement head to deliver the indium foil to a top of a lower detecting device to use the lower detecting device to detect a center position of the indium foil; and
using the controller to perform an alignment operation based on the center position of the substrate and the center position of the indium foil.

8. An indium foil processing machine, comprising:
a platform having at least one working area and at least one feeding area;
at least one feeding device disposed in the at least one feeding area and configured to supply a plurality of indium foils;
a delivery device disposed in the at least one working area and configured to deliver a plurality of substrates along a direction;
at least one placement head disposed on the platform and movably along an X axis, a Y axis, and a Z axis on the platform, wherein the at least one placement head is configured to suck and deliver the indium foils, and attach the indium foils on the substrates;
at least one laser distance sensor disposed on the platform, wherein the at least one laser distance sensor is configured to measure a reference height of the placement head without carrying any indium foils, and a detecting height of the placement head after the placement head performs an indium foil suction operation; and
a controller signally connected to the at least one laser distance sensor, wherein the controller is configured to receive the reference height and the detecting height, and determine whether an indium foil number sucked by the placement head during the indium foil suction operation is abnormal based on a difference between the reference height and the detecting height.

9. The indium foil processing machine of claim 8, wherein the platform further comprises a recycle area, and when it is determined that the indium foil number sucked by the placement head during the indium foil suction operation is abnormal and the indium foil number sucked by the placement head is plural, the placement head is further configured to deliver the indium foils sucked by the placement head to the recycle area to recycle the indium foils.

10. The indium foil processing machine of claim 9, wherein the recycle area is disposed at one side of the working area and at the same side as the feeding area.

11. The indium foil processing machine of claim 8, wherein a number of the at least one feeding area is the same as a number of the at least one working area.

12. The indium foil processing machine of claim 8, wherein each of the at least one placement head corresponds to each of the at least one working area and each of the at least one feeding device.

13. The indium foil processing machine of claim 8, further comprising:
at least one upper detecting device movably disposed on the platform and signally connected to the controller, wherein the upper detecting device is configured to measure a center position of each of the substrates in the at least one working area, and transmits the center position to the controller; and
at least one lower detecting device disposed on the platform and signally connected to the controller, wherein the lower detecting device is configured to measure a center position of an indium foil sucked by the placement head, and transmit the center position of the indium foil to the controller for the controller to perform an alignment operation.

14. The indium foil processing machine of claim 13, wherein a number of the at least one upper detecting device corresponds to a number of the at least one working area.

15. The indium foil processing machine of claim 13, wherein a number of the at least one lower detecting device corresponds to a number of the at least one working area.
